(19) United States
(12) Patent Application Publication
(10) Pub. No.: US 2004/0005927 A1
(43) Pub. Date: Jan. 8, 2004

(54) Facility for remote computer controlled racing

(76) Inventors: Victor G. Bonilla, Scottsdale, AZ (US); James W. McCabe, Scottsdale, AZ (US)

Correspondence Address: Brian C. Kunzler, Suite 425, 10 West 100 South, Salt Lake City, UT, 84101, US

(21) Appl. No.: 10/421,371

(22) Filed: Apr. 22, 2003

Related U.S. Application Data
(60) Provisional application No. 60/374,440, filed on Apr. 22, 2002.

(51) Int. Cl. A63F 9/24; A63F 13/00; G06F 17/00; G06F 19/00; A63F 9/14

(52) U.S. Cl. 463/42; 463/60

(57) ABSTRACT

A system and method for operating a facility for remote computer controlled racing over a network are disclosed. The facility comprises a server, a racing track, at least one vehicle to be controlled, and a user station. The server comprises a user profile database containing user information and racing history. Users are ranked and assigned vehicle performance profiles depending upon their experience. The server includes a track marshal module configured to monitor vehicle usage and to override operation of a vehicle during erratic behavior. The server further comprises a behavior module that allows vehicle initialization according to the user profile. The vehicle comprises a vehicle control module configured to transmit and receive network switched packets containing vehicle control data. The vehicle control module may be configured to transmit and receive network switched packets wirelessly.

### BACKGROUND OF THE INVENTION

1. The Field of the Invention

The invention relates to facilities configured for operating remotely controlled vehicles and, more specifically, to facilities providing centralized communication with a plurality of remotely controlled vehicles over a data network.

2. The Relevant Art

Remotely controlling scaled vehicles has been a popular hobby for many years. Children and adults are fascinated by the opportunity to control vehicles that normally are not available for use, such as military vehicles or trains. Scale replicas of racecars, boats, submarines, dune buggies, monster trucks, and motorcycles are among the vehicles that are widely available for remote control enthusiasts.

Modelers and manufacturers of scaled vehicles put forth considerable time and effort to attain a scaled vehicle with a life-like appearance. For many, great pleasure is derived from controlling a realistically scaled vehicle. Many methods have been developed to control scaled vehicles. Control mechanisms exist that utilize a physical connection, such as a cable, between the vehicle and the controller. This simple control mechanism is relatively inexpensive and easy to implement but requires that the user follow the vehicle. To overcome these limitations, radio control, or R/C, mechanisms have been developed.

Radio controllers facilitate the control of a vehicle through radio transmissions. By breaking the physical link between the vehicle and controller, R/C enthusiasts are able to participate in organized group events such as racing with friends in what is known as “backyard bashing.” Additionally, R/C controllers have allowed scaled vehicles to travel over and under water, and through the air, which for obvious reasons was not previously possible with a cabled control mechanism.

Racing scaled versions of NASCAR™, Formula™, and Indy™ series racecars has become very popular because, unlike other sports, the public generally does not have the opportunity to race these cars. Although scaled racecars give the hobbyist the feeling of racing, a stock car, for example, remotely racing a scaled racecar may lack realism. In order to make a racecar visually interesting to the point of view of the racer, the racecar is normally operated at speeds that if scaled, are unrealistic. Additionally R/C is limited by the amount of channels or frequencies available for use. Currently, operators of racing tracks or airplane parks must track each user's frequency and when all of the available channels are being used, no new users are allowed to participate.

These types of racing parks have become popular among radio control enthusiasts, but the parks are not able to simulate a real race, because in order to participate in a race, the enthusiast must be within view of his or her vehicle. Additionally, the vehicles are operated from a distance, thus depriving the enthusiast of the feeling of controlling the vehicle from the viewpoint of the vehicle.

Remote control enthusiasts generally control their vehicles from the viewpoint of an observer. In order for R/C to be entertaining, R/C vehicles often perform at levels well above scaled performance. For example, a 1/10^{th} scale monster truck can achieve speeds of more than 30 miles per hour, which is an unrealistic scale speed of 300 miles per hour. Systems have been implemented that allow the control of the vehicle from the viewpoint of the vehicle. Such a system may comprise a single video camera mounted inside the vehicle. While this allows for a more realistic controlling experience, it becomes very difficult to control a vehicle that is capable of unrealistic scale speeds from a scaled point of view.

Accordingly, an apparent need exists for a facility and method of remotely controlling a plurality of scaled vehicles over a data network. Beneficially, the proposed system and method would provide a racing park that will allow multiple vehicle operators to utilize a data network for control signal transmissions as well as for storing user profiles particular to each vehicle operator. Additionally, vehicle operators in such a system would be able to remotely control a vehicle from the viewpoint of the cockpit of the vehicle, at scaled speeds, in order to reproduce a more realistic racing experience.

### BRIEF SUMMARY OF THE INVENTION

The facility for computer controlled racing of the present invention has been developed in response to the present state of the art, and in particular, in response to the problems and needs in the art that have not yet been fully solved by currently available racing facilities. Accordingly, the present invention provides a facility for computer controlled racing that overcomes many or all of the above-discussed shortcomings in the art.

In accordance with the invention as embodied and broadly described herein in the preferred embodiments, an improved facility for computer controlled racing of a plurality of remote vehicles is provided. The facility comprises a digital data network, a server configured to communicate over the digital data network, a racing track, and a vehicle configured to communicate with the server over the digital data network and operate remotely on the racing track. In one embodiment, the digital data network comprises a wireless digital data network.

Additionally, the present invention comprises a driver training apparatus configured to qualify he driving abilities of a customer before permitting the customer to operate the vehicle remotely. Drivers may improve their racing abilities on any one of a plurality of racing tracks, each configured to resemble different genres of racing. Under one embodiment, a driver station is provided and configured to substantially resemble the interior of a racing vehicle and to allow an operator to remotely control the vehicle on the racetrack. The driver station further comprises an image-viewing device configured to communicate a real-time view of the remote racing vehicle to the operator.

In one embodiment of the present invention, the vehicle further comprises a central processing unit configured to communicate with the server over the digital data network. Furthermore, the central processing unit may be configured to communicate with the server over a wireless digital data network. A video camera module is provided and configured to capture a real time view from the cockpit of the vehicle and transmit the real time view over the digital data network to the image-viewing device of the operator.

In one embodiment of the present invention, the server further comprises a driver history database. The driver history database may contain information regarding wins/losses, quantity of races raced, laps led, and a history of accidents. Additionally, the server may be provided with a network interface connection configured to allow the server to communicate over the network. Alternatively, the server network interface connection may comprise a wireless network interface connection. The database may comprise a user name, a user race history, a user skill level based upon the race history, and a vehicle performance profile.

The vehicle performance profile is determined by the driver experience and comprises an acceleration profile, a braking profile, a maximum speed profile, and a steering profile. The performance of the vehicle is set to match the driver vehicle performance profile dynamically by a track marshal. The track marshal module is further configured to override a user control signal with an administrator control signal in order to safely control the vehicle.

In one embodiment, the server may also comprise a behavior module operating within the server and configured to assign a user profile to a vehicle. The behavior module may also be configured to assign the user vehicle to a position in a starting lineup of a race. Additionally, the behavior module is further configured to adjust a performance parameter of the vehicle according to an assigned skill level of the user.

The facility of the present invention also comprises a method for monitoring the skill level of a driver and allocating performance according to the driver's ability. The method comprises communicating information from a server over the digital data network, operating a vehicle remotely on the racing track, communicating information between the vehicle and the server over the digital data network, controlling the racing vehicle remotely over the digital data network, allocating performance of the vehicle according to the driver's abilities, updating a driver history profile, and promoting or demoting the driver to a performance bracket according to the driver history profile.

In one embodiment, communicating information between the vehicle and the server involves transmitting network switched packets over a wireless digital data network. Additionally, the method may also comprise overriding the vehicle or reducing the performance of the vehicle to prevent abuse.

In one embodiment, the facility for remote computer controlled racing may also comprise a computer usable medium readable by a computer, tangibly embodying a program of instructions executable by a computer to perform method steps for remote computer controlled racing over a network.

These features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram illustrating one embodiment of a facility for remote computer controlled racing in accordance with the present invention.

FIG. 2 is a schematic block diagram illustrating one embodiment of a computer controlled racing system in accordance with the present invention.

FIG. 3a is a schematic block diagram illustrating one embodiment of a vehicle control data packet in accordance with the present invention.

FIG. 3b is a schematic block diagram illustrating one embodiment of a vehicle feedback data packet in accordance with the present invention.

FIG. 4 is a perspective view diagram illustrating one embodiment of a racing booth for remote computer controlled racing in accordance with the present invention.

FIG. 5 is a perspective view of one embodiment of a computer controlled racing vehicle in accordance with the present invention.

FIG. 6a is a schematic block diagram illustrating one embodiment of a two dimensional video camera module in accordance with the present invention.

FIG. 6b is a schematic block diagram illustrating one embodiment of a three dimensional video camera module in accordance with the present invention.

FIG. 6c is a schematic block diagram illustrating one embodiment of a 360° three dimensional video camera module in accordance with the present invention.

FIG. 7 is a schematic block diagram illustrating one embodiment of a vehicle control module in accordance with the present invention.

FIG. 8 is a schematic block diagram illustrating one embodiment of a racing track for remotely computer controlled vehicles in accordance with the present invention.

FIG. 9a is a schematic block diagram illustrating one embodiment of a racing bracket system in accordance with the present invention.

FIG. 9b is a schematic block diagram illustrating one embodiment of a user identification card in accordance with the present invention.

FIG. 10 is a flow chart diagram illustrating one embodiment of a method for computer controlled racing in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

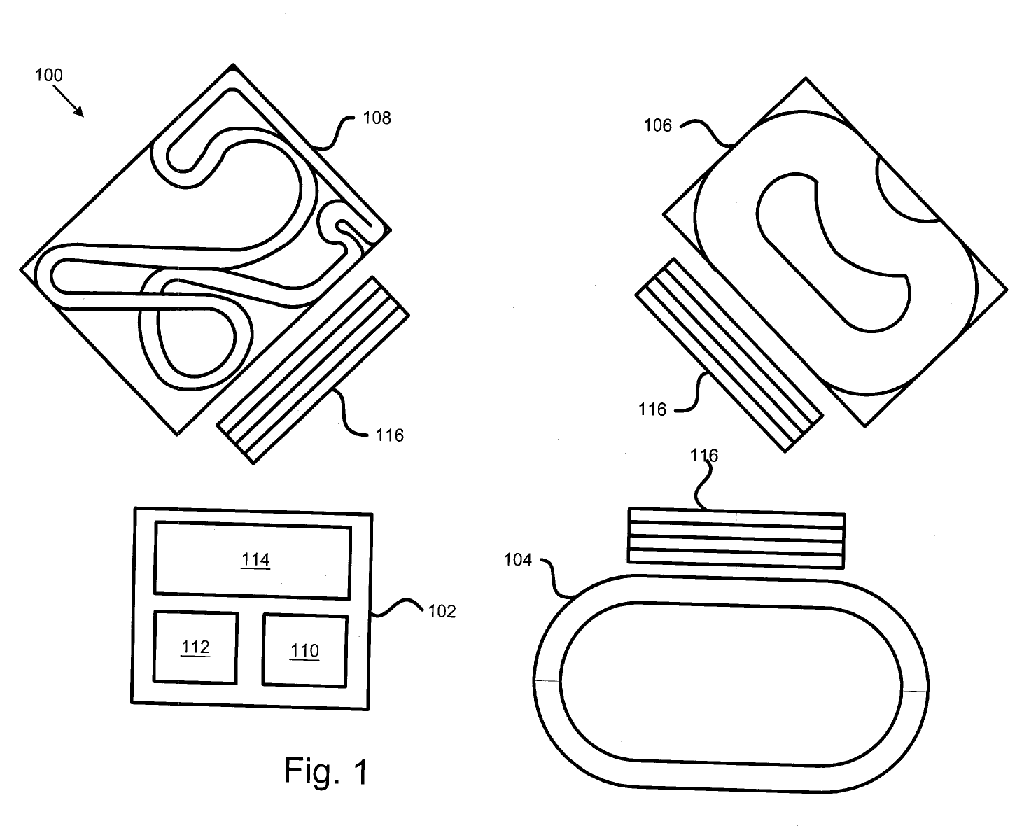

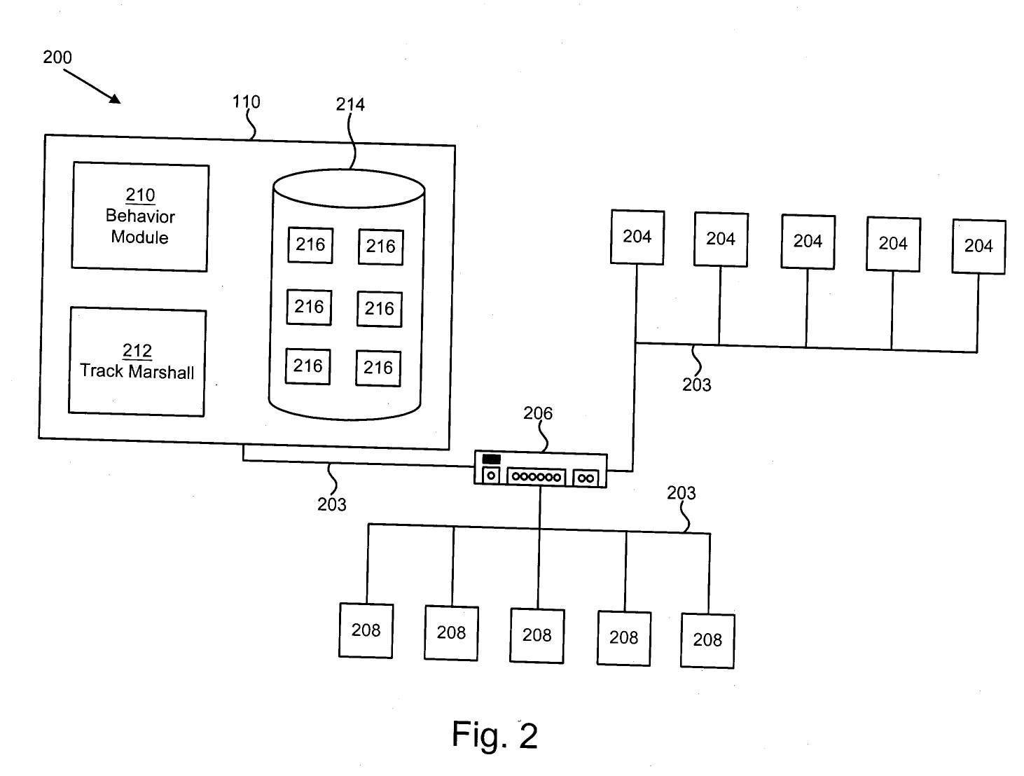

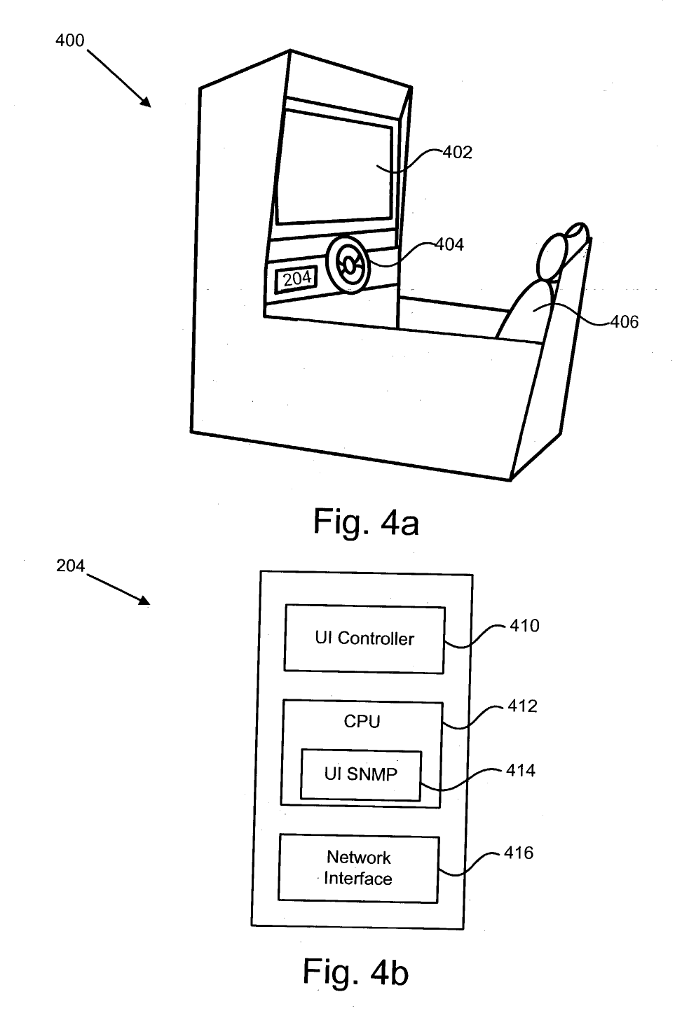

FIG. 1 shows one embodiment of a facility for remote computer controlled racing over a digital data network. The facility 100 may comprise a driver location 102, and a plurality of racing tracks 104, 106, and 108. In one embodiment, the driver location 102 comprises a building configured with a server 110, a driver station 112, and a retail store 114. The server 110 will be described in greater detail below with reference to FIG. 2. The driver station 112 is configured to substantially resemble the interior of a racing vehicle. Alternatively, the driver station 112 may be configured much like a booth. Such a booth is described below with reference to FIG. 4a.

In one embodiment, the retail store 114 may comprise a store selling various racing themed products. Alternatively, the retail store 114 may comprise an arcade where novice drivers may practice their driving skills on virtual racing games before being allowed to participate in a remote race on one of the tracks 104, 106, or 108. Additionally, the facility 100 may comprise a plurality of stands 116, from which spectators may watch the races.

FIG. 2 shows one embodiment of a computer controlled racing network 200 that may be implemented for communicating with a vehicle operated remotely. The network 200 includes a server 110, one or more data channels 203, one or more user interface (UI) modules 204, a router 206, and one or more vehicle control modules 208. Alternately, the network 200 may be configured to accommodate a single UI module 204 or a single vehicle control module 208. Using inherent characteristics of the illustrated network 200, the distinct vehicle control modules 208 need not communicate on different frequencies. By implementing the racing system as a racing network 200 as illustrated, each vehicle control module 208 may be provided with a different network address and thus be seen as a separate device on the network 200, thereby overcoming many limitations of the prior art with regard to the quantity of users that can race simultaneously.

In one embodiment, the data channel 203 comprises a standard Ethernet network. The configuration of the network 200 given herein is by way of example only and other configurations as implemented by one skilled in the art may be implemented to maintain the intention and functionality of the network 200.

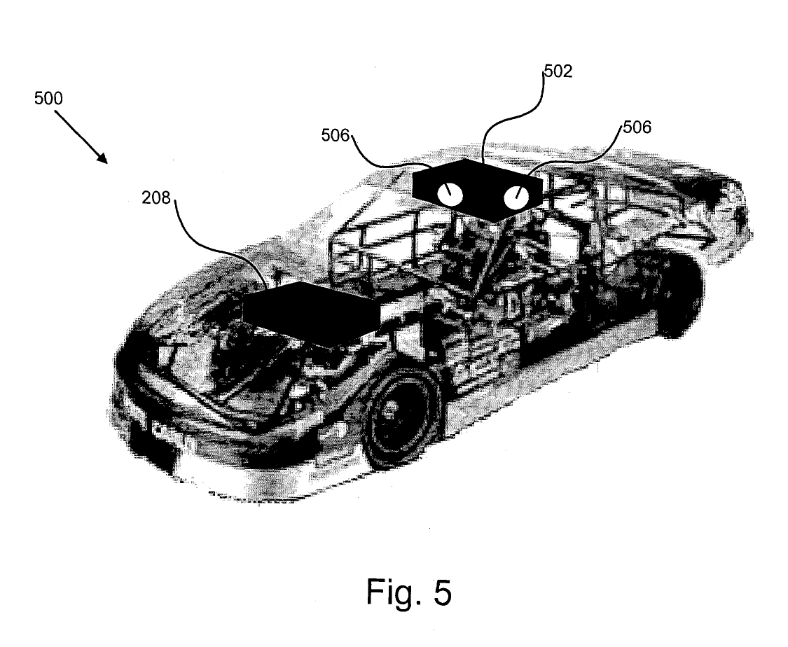

The depicted server 110 includes a behavior module 210, a track marshal module 212, and a user profile database 214. In one embodiment, the behavior module 210 is configured to assign a user's vehicle to a position in a starting lineup of a race. One embodiment of the user's vehicle will be described further with reference to FIG. 5. Additionally, the position assigned in the starting lineup may be determined by the past performance of the user. For example, in a race with multiple users, the user with the best past performance may be assigned the first position, also known as the pole position, in the starting lineup.

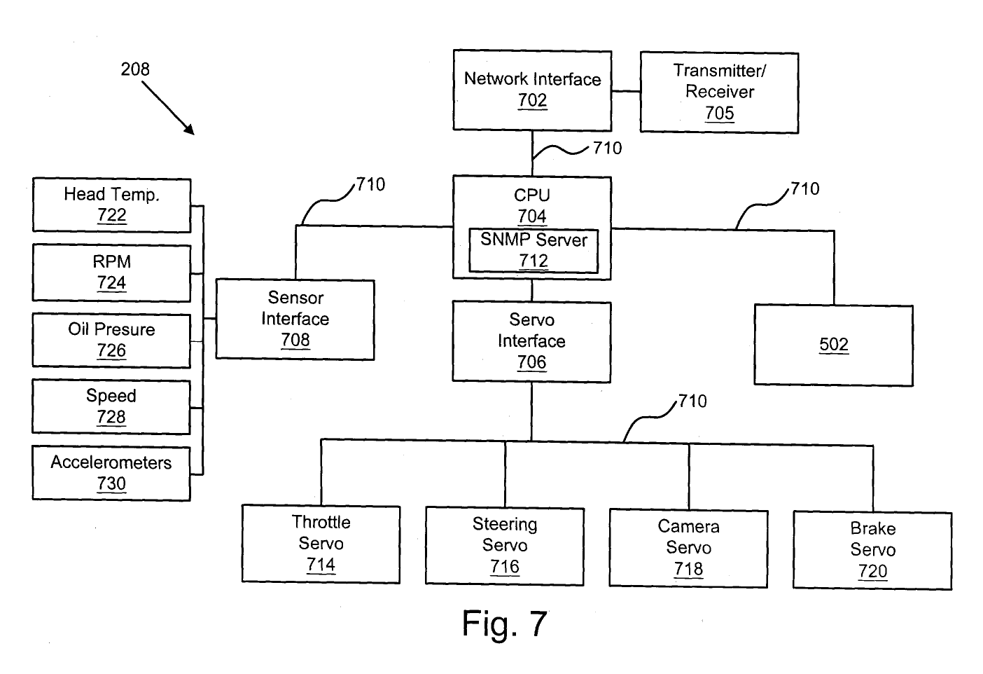

The behavior module 210 may also be configured to adjust the user's performance level with the vehicle. In one embodiment, the behavior module 210 may assign a performance limit to the vehicle according to the past performance of a user. For example, if a user has a history of damaging or dangerous behavior with the vehicle, the behavior module 210 may limit the top speed and or cornering ability of the vehicle. In one embodiment, the performance limit is stored in the user profile database and transmitted via the corresponding vehicle control module 208 to the vehicle, which then sets the vehicle's performance parameters, such as control speed, effectively tuning the performance of the vehicle. The vehicle control module 208 will be discussed in greater detail with respect to FIG. 7.

Initially, the performance of a vehicle may be limited by the behavior module 210 in order to minimize accidents. As a user progresses, the behavior module 210, in one embodiment, increases the availability of higher performance levels to the user until a maximum scaled performance level is achieved. Additionally, the behavior module 210 may update and store information used in determining and setting the performance levels in a user profile record 216 stored within the user profile database 214.

The track marshal module 212 is configured in one embodiment to dynamically monitor the status of one or more racing vehicles. The track marshal module 212 may be configured to override the user control of a vehicle if erratic driving is detected. For example, an administrator (not shown) may watch the race and in the event that the administrator views abusive or dangerous behavior from a user, the administrator may use control provided by the track marshal module 212 to override communications with the vehicle control module 208 of the identified vehicle.

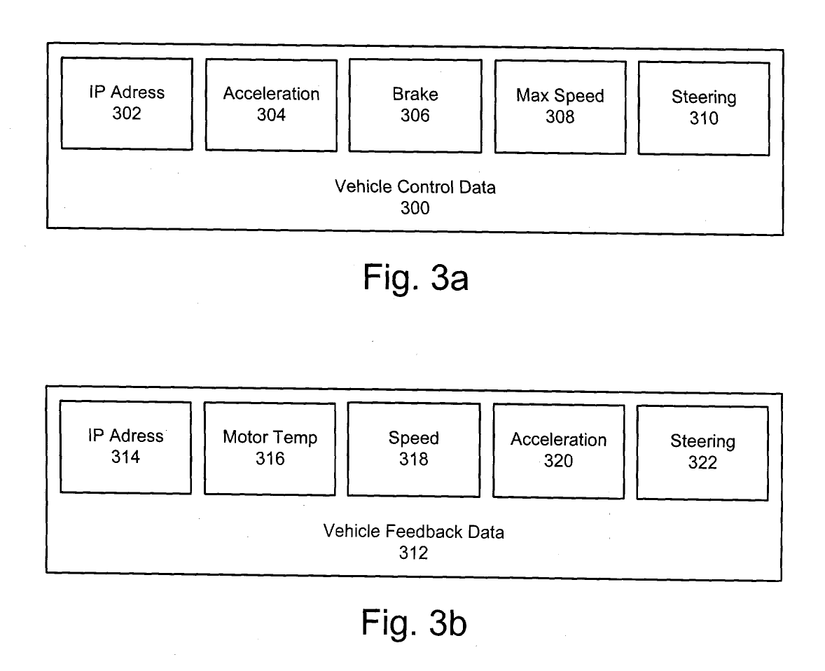

FIG. 3a illustrates one embodiment of vehicle control data 300. Under a preferred embodiment of the present invention, the vehicle control data 300 may comprise one or more network switchable packets. Preferably, the vehicle control data 300 contains an internet protocol (IP) address 302, an acceleration setting 304, a brake setting 306, a maximum speed setting 308, and a steering setting 310. Of course, not all of this data need be present and additional data may also be transmitted in the described packets. The IP address 302 enables correct routing of the vehicle control data 300 between a user and a vehicle, which will be described in greater detail below with respect to FIG. 5. IP addressing and the details thereof are well known to those skilled in the art.

In one embodiment a single packet of vehicle control data 300 may contain various setting data including, for example, the acceleration setting 304, the brake setting 306, the maximum speed setting 308, and the steering setting 310. Alternatively, each vehicle control data 300 packet may contain only one setting to be updated. The manner in which the vehicle control data 300 is utilized will be discussed in greater detail below.

Referring now to FIG. 3b, shown therein is one embodiment of vehicle feedback data 312. The vehicle feedback data 312 is configured in a manner substantially equivalent to the vehicle control data 300. In one embodiment, the vehicle feedback data 312 contains at least an IP address 314. Alternatively, the vehicle feedback data 312 comprises one or more of a motor temperature 316, a speed 318 at which the vehicle is traveling, an acceleration 320 of the vehicle, and a steering position 322. In alternative embodiments, the settings 316, 318, 320, and 322 may comprise a list of environmental variables of the vehicle.

FIG. 4a is a perspective view of a booth 400 of the present invention. In one embodiment, the booth 400 may be used in place of the driver station 112 of FIG. 1. The booth 400 comprises an image viewing device 402, a vehicle control apparatus 404, a moveable seat 406, and the user interface module 204. The vehicle control apparatus 404, in one embodiment, is configured to substantially resemble a steering wheel 404, and acceleration/braking pedals (not shown). The moveable seat 406 is configured to receive vehicle feedback data 312 and translate such variables as speed 318, acceleration 320, and steering 322 into seat movement that will cause the driver to experience the sensation of actual racing.

FIG. 4b is a schematic block diagram illustrating one embodiment of the UI module 204 of FIG. 2. The UI module 204 is configured for communicating with a vehicle 500 operated remotely over a network. The depicted UI apparatus 204 includes a UI controller 410, a CPU 412, a UI simple network management protocol (SNMP) module 414, and a network interface connection 416. The UI controller 410 is preferably configured to convert vehicle control data 300 from the user into data recognizable by the CPU 412 and the UI SNMP module 414.

In one embodiment of the present invention, the CPU 412 is configured to communicate with the UI controller 410, the UI SNMP module 414, and the network interface connection 416. The input received from the user through the UI controller 410 is configured by the CPU 412 and the UI SNMP module 414 in order to be transmitted by the network interface 416 to the vehicle 500 through a transmission medium (not shown). The UI module 204 is configured to interact with the user and translate controls such as steering wheel, acceleration, and braking input.

In one embodiment, the transmission medium comprises a standard Ethernet network, the operation of which will be familiar to one skilled in the art. In a further embodiment, the transmission medium may comprise a wireless peer-to-peer or infrastructure network, also readily known and/or commonly available.

FIG. 5 shows a vehicle 500 that is controllable over a network and which may be operated in one embodiment with the facility for computer controlled racing of the present invention. As depicted, the vehicle includes a video camera module 502 and a vehicle control module 508. The vehicle 500 is in one embodiment replicated at one-quarter scale, but may be of other scales also, including one-tenth scale, one-fifth scale, and one third-scale. Additionally, the network-controlled vehicle 500 may embody scaled versions of airplanes, monster trucks, motorcycles, boats, buggies, and the like. In one embodiment, the vehicle 500 is a standard quarter scale vehicle 500 with centrifugal clutches and gasoline engines. Alternatively, the vehicle 500 may be electric or liquid propane or otherwise powered. Quarter scale racecars are available from New Era Models of Nashua, N.H. as well as from other vendors, such as Danny's ¼ Scale Cars of Glendale Ariz.

The vehicle 500 is operated by remote control, and in one embodiment an operator need not be able to see the vehicle 500 to operate it. Rather, a video camera module 502 is provided with one or more cameras 506 connected to the vehicle control module 208 for displaying the points of view of the vehicle 500 to an operator. The operator may operate the vehicle 500 from a remote location at which the operator receives vehicle control data and optionally audio and streaming video. In one embodiment, the driver receives the vehicle control data over a local area network. Under a preferred embodiment of the present invention, the video camera module 502 is configured to communicate to the operator using the vehicle control module 208. Alternatively, the video camera module 502 may be configured to transmit streaming visual data directly to an operator station.

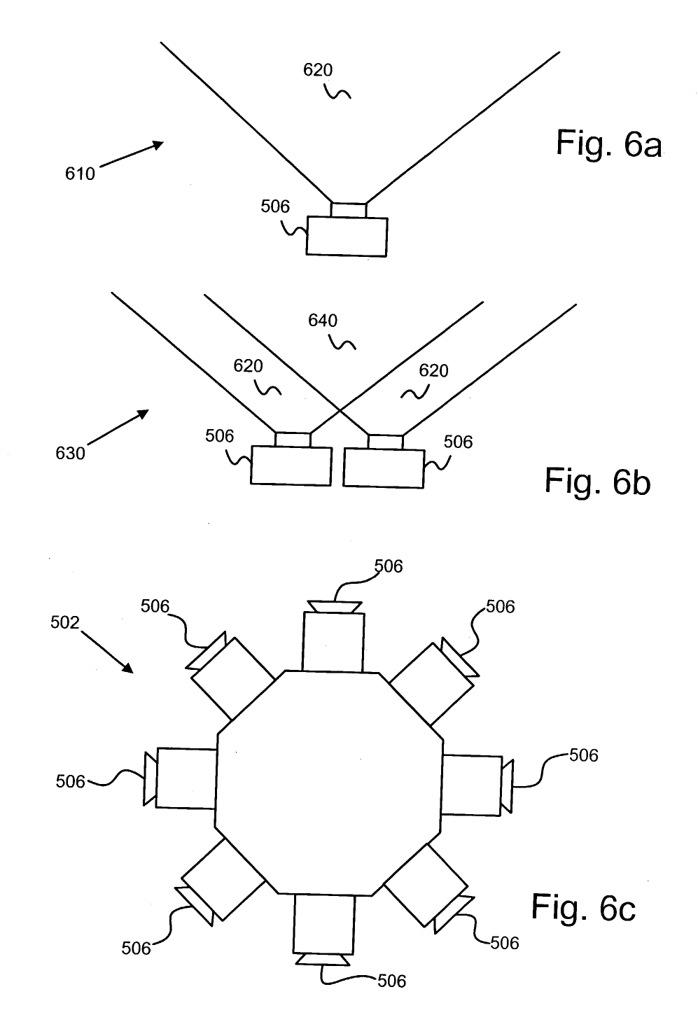

FIG. 6a depicts a plan view 610 of a single camera 506 that may be mounted to the vehicle 500 as discussed in conjunction with FIG. 5. The depicted camera 506 has a specific field of view 620, delineated by a pair of the angled solid lines that is determined by the design and manufacture of the camera 606. In one embodiment, the field of view 620 is fixed and, in an alternate embodiment, the field of view 620 of the camera 606 may be dynamically adjusted using either optical or digital processes. The field of view 620 captured by the illustrated camera 606 generally produces a two dimensional image.

FIG. 6b illustrates a plan view 630 of a pair of cameras 506 that may be co-mounted to the vehicle 500. As in the previous figure, each depicted camera 506 has a specific field of view 620. Similarly, the field of view 620 of each camera 506 in the pair may be fixed or dynamically adjustable. According to the mounting configuration, including the relational orientation of the pair of cameras 506, the fields of view 620 may wholly or partially overlap. The video camera module 502 may then process the combination of captured fields of view 620 and create a three dimensional image.

Referring now to FIG. 6c, shown therein is one embodiment of the video camera module 502. The illustrated video camera module 502 includes a plurality of video cameras 506. The cameras 506 may be mounted in a circular manner so as to provide a combined panoramic view created from the plurality of corresponding fields of view 620. One advantage of the present invention is the ability to form a two dimensional, three dimensional, or 360° three dimensional image. The video camera module 502 is preferably configured to weave together the overlapping fields of view 620 of each camera 506. As discussed in conjunction with FIG. 5b, a three dimensional view is possible by processing two overlapping fields of view 620. In one embodiment, each camera 506 may be oriented to allow overlap of the fields of view 620 of the two cameras 506 that are closest.

FIG. 7 shows one embodiment of the vehicle control module 208. The vehicle control module 208 in one embodiment includes a network interface module 702, a central processing unit (CPU) 704, a servo interface module 706, a sensor interface module 708, and the video camera module 502. In one embodiment, the network interface module 702 is provided with a wireless transmitter and receiver 705. The transmitter and receiver 705 may be custom designed or may be a standard, off-the-shelf component such as those found on laptops or electronic handheld devices. Indeed, a simplified computer similar to a Palm™ or Pocket PC™ may be provided with wireless networking capability, as is well known in the art, and placed in the vehicle 500 for use as the vehicle control module 208.

In one embodiment of the present invention, the CPU 704 is configured to communicate with the servo interface module 706, the sensor interface module 708, and the video camera module 502 through a data channel 710. The various controls and sensors may be made to interface through any type of data channel 710 or communication ports, including PCMCIA ports. The CPU 704 may also be configured to select from a plurality of performance levels upon input from an administrator received over the network. Thus, an operator may use the same vehicle 500 to progress from lower to higher performance levels. Vehicle 500 performance may be modified by reducing steering sensitivity, acceleration, and top speed. This is especially efficacious in driver education and training applications. The CPU 704 may also provide a software failsafe with limitations to what an operator is allowed to do in controlling the vehicle 500.

In one embodiment the CPU 704 comprises a Simple Network Management Protocol (SNMP) server module 712. SNMP provides an extensible solution with low computing overhead to managing multiple devices over a network. SNMP is a well known to those skilled in the art, and therefore will not be described in great detail here. In an alternate embodiment not depicted, the CPU 704 may comprise a web-based protocol server module configured to implement a web-based protocol, such as Java™, for network data communications.

The SNMP server module 712 is configured in one embodiment to communicate vehicle control data 300 to the servo interface module 706. The servo interface module 706 communicates the vehicle control data 300 with the corresponding servo. For example, the network interface card 702 receives vehicle control data 300 that indicates a new position for a throttle servo 714. The network interface card 702 communicates the vehicle control data 300 to the CPU 704 which passes the data 300 to the SNMP server 712. The SNMP server 712 receives the vehicle control data 300 and routes the setting that is to be changed to the servo interface module 706. The servo interface module 706 then communicates a command to, for example, the throttle servo 714 to accelerate or decelerate.

The SNMP server 712 is configured to control a plurality of servos through the servo interface module 706. Examples of servos that may or may not be present in the vehicle 500, depending upon the type of vehicle 500, are a throttle servo 714, a steering servo 716, a camera servo 718, and a brake servo 720. Additionally, the SNMP server 712 may be configured to retrieve data by communicating with the sensor interface module 708. Examples of some desired sensors for a gas vehicle 500 are shown in FIG. 7 and include a head temperature sensor 722, an RPM sensor 724, an oil pressure sensor 726, a speed sensor 728, and an acceleration sensor 730.

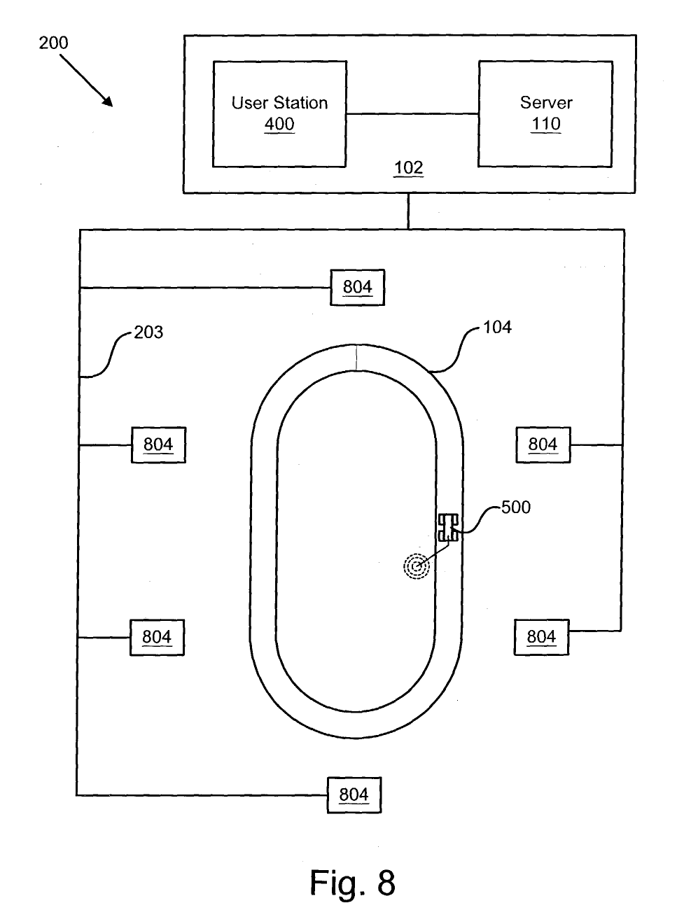

FIG. 8 shows one embodiment of an implementation of the network 200 at a racing track such as the racing track 104 of FIG. 1. The vehicle 500 may be driven in an area such as the racetrack 104 that is provided with at least one transmitter/receiver 804 distributed around the racetrack 104 for wireless transmission and reception to and from the vehicle 500. In this implementation, a vehicle 500 communicates with a transmitter/receiver 804 in order to access the server 110, which is located within the driver location 102 of the facility 100. Specific manners of implementing such an embodiment will be readily apparent to those skilled in the art of an infrastructure implementation of a wireless network 700. Alternatively, the network 200 may be implemented in a peer-to-peer mode wherein the vehicle 500 transmits and receives vehicle control data directly from a user station 806.

In one embodiment, both audio/video signals and control signals are transmitted over wireless data channels 203. For example, the audio, video, and control signals may be transmitted using the 802.11a, b, or g standard or the Bluetooth standard. However, in alternative embodiments, the control signals may be transmitted with one protocol or transmission type and the audio and video signals with another. Alternatively, vehicle control data 300 and vehicle feedback data 312 may be embedded on a monaural channel of a video signal (i.e., in between the upper and lower channels). This signal then may be transmitted as the control signals of the vehicle 500. Control signals may also be transmitted from the vehicle 500 in addition to the audio and video data transmitted by the video camera module 502. Such signals may be used to generate a display, including in one embodiment a heads up display, for the user. Thus, gauges or other displays may show speed, fuel, oil pressure, temperature, etc.

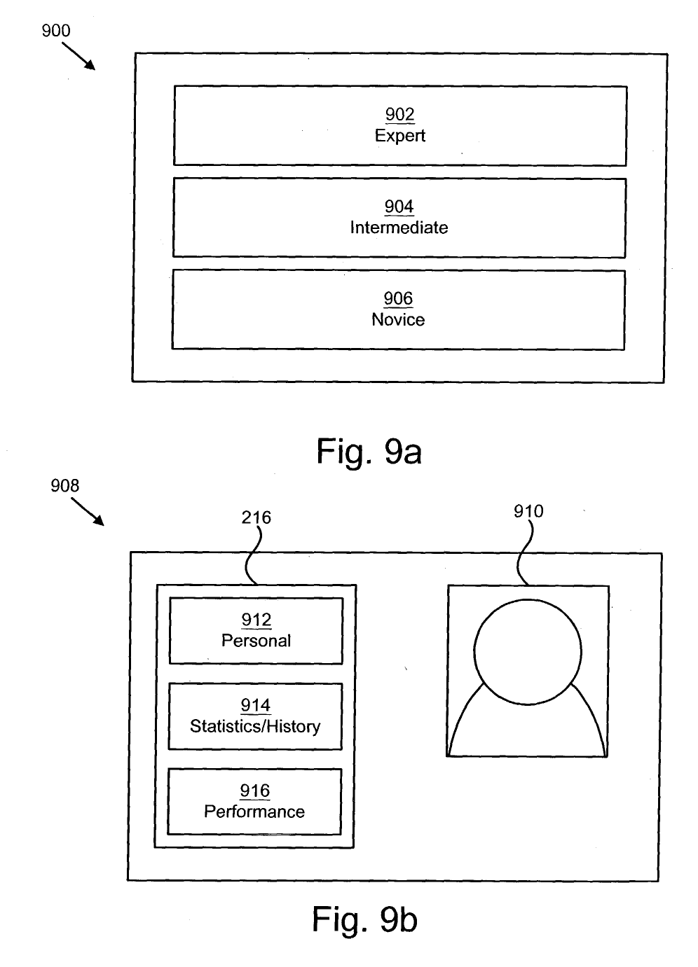

Referring now to FIG. 9a, shown therein is a schematic block diagram representing a racing bracket system 900 of the present invention. Users may be divided into an expert bracket 902, an intermediate bracket 904, and a novice bracket 906. Alternatively, the racing bracket system 900 may be implemented with any number of performance divisions. In one embodiment, a new user may be assigned to the novice bracket 906 and a performance level may be assigned to his or her vehicle 500 accordingly. For example, a user may graduate from the novice bracket 906 and advance to the intermediate bracket 904 upon winning a race or otherwise demonstrating sufficient performance control of the vehicle 500. In a similar manner, a user may advance to the expert bracket 902 and in one embodiment concurrently gain access to the full performance of the vehicle 500. Alternatively, advancement and other movement within the racing bracket system 900 may be determined on a point system.

FIG. 9b is a schematic block diagram illustrating one embodiment of a user identification card (UIC) 908. In one embodiment, the UIC 908 illustrates a picture 910 of the user and a copy 912 of the user profile 216. The copy 912 of the user profile 216 may include all or part of the data stored in the user profile record 216 stored on the user profile database 214 and may include personal information 912, statistics/history 914, and an assigned performance level 916. The user profile copy 912 may be deployed on the UIC 908 in any number of manners. For example, in one embodiment the user profile copy 912 may reside within an embedded integrated circuit. In another embodiment, the user profile copy 912 may be visibly printed on the surface of the UIC 908. The statistics/history 914 may include, but is not limited to, win-loss history, laps led during a race, and fastest speed. These factors may be used in one embodiment to determine the racing bracket 902, 904, 906 in which a user may race, as well as the assigned position within the starting lineup of a race.

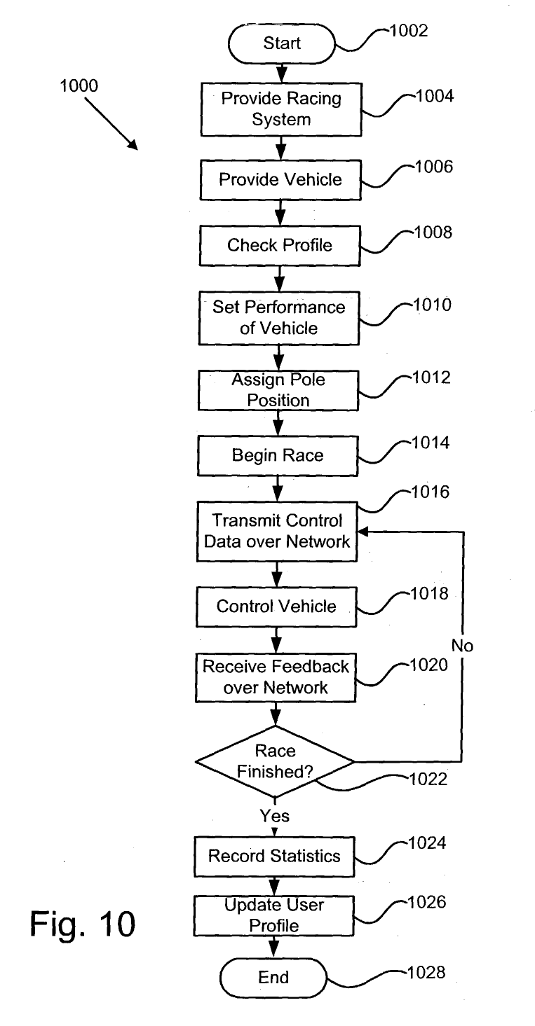

Referring now to FIG. 10, shown therein is one embodiment of a method 1000 of computer controlled racing over a network. The method 1000 starts 1002 and the racing system 100 is provided 1004. In one embodiment, the racing system 100 may be provided 1004 as a wired Ethernet network 100. In another embodiment, the network 100 may be wireless. Additionally, the vehicle 500 is provided 1006 together with the corresponding vehicle control module 208 and the video camera module 502. Subsequently, the method 1000 checks 1008 the user profile 216 of the operator, and the performance parameters of the vehicle 500 are set 1010 according to the user's recorded or assigned performance level. In one embodiment, the user is then assigned a pole position 1012 within the starting lineup of a race, and the race begins 1014.

As the user begins operating the vehicle 500, the associated vehicle control data 300 is transmitted 1016 over the system 100. The vehicle control data 300 may be transmitted 1016 wirelessly or through standard network data channels 203. The vehicle 500 receives the vehicle control data and the vehicle is controlled 1018. Upon request from the user or an administrator, including an administrator application stored on the system 100, the vehicle 500 transmits feedback data, and the server 110 receives 1020 the feedback data over the network 200. At a determined point within the communication sub-process between the server 110 and the vehicle control module 208, the method 1000 determines 1022 if the race is finished. If the race is not finished, then steps 1016, 1018, and 1020 are continuously performed until the race is finished 1022. In an alternate embodiment, the communication steps 1016, 1018, and 1020 may be performed in parallel or in another order, instead of in succession as illustrated.

When the method 1000 determines 1022 that the race is finished, the server 110 records 1024 the race statistics for the target user and the user profile record 216 is updated 1026 as required. In one embodiment, updating 1026 the user profile record 216 comprises updating the user profile database 214 and the user identification card 908. In a further embodiment, updating the user profile record 216 comprises updating the user's bracket designation 902, 904, 906. The depicted method 1000 then ends 1028. Of course, not all steps need be conducted under the invention, and additional steps may also be conducted.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A facility for computer controlled racing of a plurality of remote vehicles, the facility comprising:
a digital data network;
a server configured to communicate over the digital data network;
a racing facility; and
a vehicle configured to communicate with the server over the digital data network and operate remotely on the racing track.

2. The facility of claim 1, wherein the digital data network comprises a wireless digital data network.

3. The facility of claim 1, further comprising a driver training apparatus configured to qualify the driving abilities of a customer before permitting the customer to operate the vehicle remotely.

4. The facility of claim 1, further comprising a plurality of racing tracks, each configured to resemble different genres of racing.

5. The facility of claim 1, further comprising a driver station configured to substantially resemble the interior of a racing vehicle and to allow an operator to remotely control the vehicle on the racetrack.

6. The facility of claim 5, wherein the driver station further comprises an image-viewing device configured to communicate a real-time view of the remote racing vehicle to the operator.

7. The facility of claim 1, wherein the vehicle further comprises a central processing unit configured to communicate with the server over the digital data network.

8. The facility of claim 7, wherein the central processing unit is configured to communicate with the server over a wireless digital data network.

9. The facility of claim 1, wherein the vehicle further comprises a video camera module configured to capture a real time view from the cockpit of the vehicle and transmit the real time view over the digital data network to the image-viewing device of the operator.

10. The facility of claim 1, wherein the server further comprises a driver history database.

11. The facility of claim 10, wherein the driver history database further comprises wins/losses, quantity of races raced, laps led, and a history of accidents.

12. A racing system server for computer controlled racing, the system comprising:
a network interface connection configured to allow a server to communicate over the network with remote controlled vehicles operating vehicles in a racing facility; and
a database configured to maintain a user profile record for operators of the remote controlled vehicles.

13. The racing system server of claim 12, wherein the network interface connection comprises a wireless network interface connection.

14. The racing system server of claim 12, wherein the database further comprises a user name, a user race history, a user skill level based upon the race history, and a vehicle performance profile.

15. The racing system server of claim 12, wherein the vehicle performance profile comprises an acceleration profile, a braking profile, a maximum speed profile, and a steering profile.

16. The racing system of server claim 12, further comprising a track marshal module operating within the server and configured to dynamically adjust vehicle performance.

17. The racing system server of claim 16, wherein the track marshal module is further configured to override a user control signal with an administrator control signal in order to safely control the vehicle.

18. The racing system server of claim 12, further comprising a behavior module operating within the server and configured to assign a user profile to a vehicle.

19. The racing system of server claim 18, wherein the behavior module is further configured to assign the user vehicle to a position in a starting lineup of a race.

20. The racing system server of claim 18, wherein the behavior module is further configured to adjust a performance parameter of the vehicle according to an assigned skill level of the user.

21. A method for computer controlled racing including monitoring the skill level of a driver and allocating performance according to the driver's ability, the method comprising:
establishing a digital data network;
communicating information between the vehicle and the server over the digital data network;
training a driver to remotely operate a racing vehicle;
controlling the racing vehicle remotely over the digital data network;
allocating performance of the vehicle according to the driver's abilities;
updating a driver history profile; and
promoting or demoting the driver to a performance bracket according to the driver history profile.

22. The method of claim 21, wherein communicating information between the vehicle and the server further comprises transmitting network switched packets.

23. The method of claim 22, wherein communicating information between the vehicle and the server further comprises transmitting and receiving network switched packets over a wireless digital data network.

24. The method of claim 21, further comprising overriding the vehicle to prevent abuse.

25. The method of claim 21 further comprising reducing vehicle performance to prevent abuse.

26. A computer usable medium readable by a computer, tangibly embodying a program of instructions executable by a computer to perform a method for computer controlled racing over a network, the method comprising:
communicating information from a server over the digital data network;
operating a vehicle remotely on the racing track;
communicating information between the vehicle and the server over the digital data network;
training a driver to remotely operate a racing vehicle;
controlling the racing vehicle remotely over the digital data network;
allocating performance of the vehicle according to the driver's abilities;
updating a driver history profile; and
promoting or demoting the driver to a performance bracket according to the driver history profile.
